(19) United States
(12) Patent Application Publication
(10) Pub. No.: US 2003/0046162 A1
(43) Pub. Date: Mar. 6, 2003

(54) Private advertising, entertainment and informational digital networks for out-of-home and outdoor venues

(76) Inventor: William Charles Nestel, Malibu, CA (US)

Correspondence Address: William Charles Nestel, 11924 White Water Lane, Malibu, CA, 90265, US

(21) Appl. No.: 10/161,763

(22) Filed: Jun. 4, 2002

Related U.S. Application Data
(60) Provisional application No. 60/296,925, filed on Jun. 8, 2001.

(51) Int. Cl. G06F 17/60

(52) U.S. Cl. 705/14

(57) ABSTRACT

A system and method of broadcasting information to consumers in public areas (billboards, malls, transit shelters, sports venues) via a network of interlinked outdoor displays (outdoor broadcasting networks “OBNS”), whereby content delivery is remotely controlled from a central location.

OBN is a new mass communication medium that enables simultaneous distribution and updates of multi-lingual, short form content (advertisements, news, PSAs, etc,) based upon geographic, ethnic or demographic factors, such as venue, event, time of the day.

OBN extends to all outdoor venues regardless of venue ownership. Property owners become network affiliates, converting the current “space rental” paradigm of outdoor advertising to a “time purchase” media buy model employed in the television and radio industries.

This application of technology and novel business method will transform the industry, creating efficiencies of operation, offering advertisers targeted messages and providing consumers with timely information.

### CROSS REFERENCE TO RELATED APPLICATION

This application claims the benefit of the filing date of U.S. Provisional Application No. 60/296,925, filed Jun. 8, 2001.

### FIELD OF THE INVENTION

This invention relates to a centralized system and method for distributing and displaying digital media, in any language, in full motion and/or still images, across private, proprietary electronic networks of affiliated and/or non-affiliated third party venues in out-of-home and outdoor locations (“network affiliates”).

The creation and implementation of out-of-home and outdoor digital advertising networks offer a completely new paradigm to current outdoor and out-of-home advertising methodologies, where advertising space is now rented site by site, location by location, transit shelter by transit shelter, billboard by billboard, mall sign by mall sign, etc., a marketing and business method which has been in existence for over a century, requiring intensive labor, time and costs.

The creation and systemic integration of proprietary advertising, informational and entertainment networks will enable the licensing to advertisers and other content providers the right to “broadcast”, control and monitor, from one central location, constantly changing and updating advertising, entertainment and informational content (“programming”) on a scheduled basis to as few or as many of network affiliates (i.e., those out-of-home and outdoor locations as are connected to the central network location) as desired, whether or not such affiliates are owned or controlled by one or more entities, thereby leveraging advertisers' and other content owners' ability to: reach millions of people daily by virtue of becoming part of an integrated outdoor digital advertising network; display different ads simultaneously throughout the same network at the same time or at different times, as desired; reach targeted demographics/consumers based upon the event, time of day, day of the week, and other benefits of the creation of a new mass medium of communications.

This invention/method of business is not theoretical. It has been successfully tested in pilot form at a professional football stadium, a retail chain and at a major league ballpark.

### DESCRIPTION OF THE RELATED ART

In the current marketplace, advertisers are presented with the following traditional business models for distributing their messages to consumers: “buying time” (generally 15-30-60 seconds in duration) on a radio or television broadcasting, cable or satellite network; ad banners or “pop-up” images on the Internet or wireless devices; “renting space” for periods of weeks or months on billboards, transit shelters, or mall displays; or, purchasing space in a particular daily, weekly or monthly print publication. Agencies generally engage media buyers to separately purchase such advertising across the aforementioned media. This paradigm of advertising has been in place in the United States for over four generations.

Most of the advertising in television and radio is centrally managed and sold through a small network of large advertising agencies and media buyers, which purchase time from major and regional networks. The commercials are electronically produced and transmitted by satellite so a television network such as ABC, CBS, NBC, or a radio network such as Premiere Radio Network or Westwood One (divisions of Clear Channel) can distribute ads and other content to their various affiliates electronically.

The production process to display ads in outdoor advertising is also time consuming and inefficient. Advertisers in out-of-home and outdoor locations will produce a sign (some hand painted, but generally made of vinyl) and ship the ads across the country where they are manually transported to the site and installed (on a billboard, in a light box at a mall or transit shelter, etc.) and, when the rental period has expired, manually removed.

Again, each of these advertisements are created and displayed for individual locations and are “static”, i.e., cannot be dynamically changed or updated remotely.

There are currently a small number of electronic signs particularly in high-density urban locations. However, these displays are not interconnected or controlled from one central location, nor are they connected to or coordinated with other digital display signs.

The onset of the digital revolution and the resultant digitation of media and explosive growth of computer networks has provided a way to “push” (produce and distribute) or “pull” (obtain from remote sites) digital content in the form of text, graphics and audio, as well as full motion video to individual users as well as corporate intranet networks. Additionally, a computer connected to the Internet or any other computer network (e.g., Intranet) can also be used to interact in real time with other computers connected to such network.

The tools of the advertising industry have also evolved over the years with the audiovisual image becoming omnipresent. Yet despite the incursion of new technologies into many fields of business, with the microchip and digital technology changing many aspects of modern life, including marketing and distribution systems, the outdoor advertising business (with the exception of a few LED billboards and scoreboards in sports venues) remains largely static and unchanged.

In the out-of-home/outdoor marketplace, the production and distribution process has also not changed for the better part of fifty years. Advertisers must select individual vendors who own or control a particular space (a mall, billboard, transit shelter, sports venue) and individually rent the space for a negotiated fee for a predetermined period of time. The process is magnified when one recognizes that there are literally millions of locations between billboards, transit shelters, malls and sports venues in the United States alone.

The process of selecting each advertisement for each separate location, producing the content (usually on paper or vinyl), shipping it to the venue owner, paying for the human labor to transport, install and deinstall the ad when the particular rental period has run its course is time consuming, expensive, and somewhat inefficient because the it is not “electronically integrated”.

Yet another problem with the present outdoor advertising system is that advertisers and owners must sell the advertising through several different channels requiring disparate expenditures in each of those markets. Each ad buy usually involves multiple client charges for each item (vinyl billboard, mall or transit placard) created, produced, transported, installed and removed, a process which is highly labor intensive as well as a timely process.

These costs, especially when incurred across continents, can dramatically increase the costs of distribution, significantly cutting into operating margins.

In today's fast moving society, advertisers are constantly introducing products and services which are “time-sensitive” and offered for particular demographics and targeted audiences, communicated to consumers at various out-of-home and outdoor locales and further subject to intense competition with other brands. Because of the lengthy process of selecting the venue, negotiating the terms, producing the advertising content, delivering and installing the ad, it can take many weeks or months from conception to installation. By then the time sensitivity of the idea may make the ad have less impact and immediacy to the consumer.

Furthermore, advertisers recognize that the United States is a melting pot of a variety of ethnic backgrounds and consumers whose native language is not English. Advertisers in the out of home marketplace are limited because the methodology of producing an outdoor ad does not include the benefit of electronically displaying the ad in multiple languages. For instance, in a venue used for sports, family shows, conventions and concerts, an advertiser generally has the same signage displayed in a concourse for an entire year, because it is too cumbersome to create and install new static ads in the concourses for each event throughout the year.

To conclude, the distribution and display of outdoor and out-of home advertising has remained substantially of the same character and nature as when the industry was relatively young at the turn of the 20th Century. Given the fast paced economy and the need of brand owners and advertisers to constantly communicate efficiently and effectively to consumers of all ages, cultural heritage and ethnic backgrounds, these ancient methodologies have become outmoded, costly and inefficient.

Benefits Of The Invention.

The present invention (system and method) possesses immediate “real world” value and will quickly produce a useful, concrete and tangible result for advertisers, out-of home and outdoor venue owners and consumers alike.

Specifically, this invention/business method is designed to modernize a stagnant outdoor advertising industry, increase the efficiencies of operation for advertisers (especially national and global brands) to reach their consumers with timely and targeted information thereby allowing an advertiser to construct meaningful and intelligently conceived ads that will reach millions of people daily throughout the United States as well as globally, competing favorably with the reach of television and radio, but also having the unique ability to localize and customize the same ad throughout the day at each network affiliate locale and, if desired, display the ad in multiple languages, thus exceeding the limitations of radio and television.

In short, this invention introduces a new mass medium for advertising.

The advertising business will benefit greatly by the aforementioned invention through reducing overhead costs, including those related to the replication, distribution and removal annually of millions of billboard, mall, sports venue and transit shelter advertising vinyl and placards by evolving to a paradigm here presented and inspired by systems used in other media such as television and radio-that being the creation of so-called virtual advertising networks in outdoor and out-of-home venues.

For venue owners, this invention allows, on any given day, a national advertiser to distribute/launch/communicate to myriad consumers in out-of-home locations in a coordinated and dynamic fashion—e.g., in Los Angeles on a Fall Sunday afternoon, on LED and plasma screens at a Lakers game at The Staples Center, which seats 20,000 people per event, LCD monitors located at concession stands at San Diego Chargers NFL game at Quaalcom Stadium in San Diego, which seats 70,000 people per game, to CRT and projector screens located a baseball game at Dodgers Stadium in Los Angeles which seats 50,000 fans a game, to an LED screen in Hollywood-Highland Mall, which receives 25,000 visitors that day, and on digital billboards adjacent to The Santa Monica Freeway, The Harbor Freeway, The Golden State Freeway and The San Diego Freeway which surround the aforementioned venues and are seen by an aggregate of 750,000 drivers that day, to become part of an integrated advertising and communications network reaching millions of people, thereby enticing non-traditional advertisers to take part.

This invention allows advertisers to create their own virtual network(s) of proprietary entertainment, branding, information, promotions and advertising, or to create outdoor/out-of-home advertising “syndicates” with other advertisers and content owners to distribute content, much like an outdoor version of a television or radio syndicated network.

### DESCRIPTION OF THE INVENTION

It is accordingly the object of the invention to provide a new method for distributing and licensing digital advertising and other media that overcomes the above-mentioned disadvantages of the heretofore used methodologies for out-of-home and outdoor advertising and that harnesses available technology, including the immediacy and popularity of high-end digital content without relinquishing control of the distribution from the advertisers and other content owners.

There is provided, in accordance with the invention, a system and method for distributing and displaying digital media, including advertising, entertainment, information and other content, simultaneously or not, as desired, across a private and proprietary network of affiliates in out-of-home (e.g., malls, retail stores, sports venues) and outdoor (e.g., billboards, transit shelters) locations.

The network will be comprised of one or more advertisers or content providers seeking to reach targeted consumers across an array of demographics at various outdoor locations, depending upon the event, the ad and the campaign strategy. Advertising and content will be preselected and displayed at affiliate locations based upon the particular event (sports, concert, family show, convention), the geographical location, the time of the day or the day of the week.

The method displays digital advertisements controlled from one central location targeted to the venue, the time of day, the day of the week, the event, and the ethnic/cultural demographics.

The venue is tied to other outdoor venues throughout the United States and globally. Special ads can also be launched dynamically, such as offering an “instant sale” of merchandise to clear unwanted inventory.

The prime technological leap allowing this invention to become a reality is the ability of computers to distribute, store and display information digitally. Thus, pilot electronic networks have been installed within a few national chain stores where management can communicate with storeowners and employees, or issue information and ads to shoppers at the venue. A very small number of theater lobbies now display digital advertising. Transit areas (airports, bus stations, etc.) and sports venues now display key up to date information such as weather, flight arrival times and news. These “ingrown” networks are created and run solely within such individual venues, i.e., content (advertising, entertainment, information) is distributed within the singular venue, and is not connected to any other location.

The network will be generally controlled from one centralized location (network server). Content will be distributed by high-speed phone lines or satellite to remote servers (site and display) at each network affiliate's location.

The technology allows content to be scheduled and monitored from one central location, as well as the affiliate or advertiser. New content and advertising can be dynamically inserted as desired. Thus, at 7 PM EDT an advertiser can run one ad simultaneously at 20 arenas across the U.S., or as many different ads at such moment as desired to reach a targeted audience (ice hockey, concert, family show, etc.). An affiliate may belong to more than one network.

The network can be owned and controlled by: (1) A media company which controls outdoor or out-of-home locations and wishes to syndicate advertising; (2) Mall owners, sports venue owners, transit owners, municipalities and other organizations which control outdoor real estate; (3) an advertiser (e.g., soft drink, apparel, bank, film company) which creates or licenses its programming advertising and content and chooses which out-of-home or outdoor affiliates are to receive its programming; (4) A group of advertisers who “syndicate” their combined advertising and programming; or (5) one or more content providers who extend their broadcasting, satellite or cable programming by creating unique content for out of home and outdoor networks.

The network “affliliates” will be out-of-home and outdoor venues that are interconnected by the network, even though they are not owned and controlled by one entity. Thus, the network affiliates may be comprised be a group of sports venues (arenas, ballparks, stadiums), malls owners, billboard managers, transit locations/ shelters and retail stores.

Conversely, network owners can also be “network affiliates”.

More than one network can co-exist with other(s) in the same digital space. For example, a soft drink company can create its own proprietary network, which is distributed to arenas, stadiums and ballparks for a series of concerts. The same digital spaces can be used for another network controlled by an athletic shoe company which creates a network for the same venue and is licensed the right to advertise and distribute content for athletic events, tied through the network to other stadiums and ballparks which are part of the electronic/digital system.

Revenue is generated through charging the advertiser or content provider a fee to distribute its content and advertising. The fee is shared between the network and the affiliate.

In accordance with a further object of the invention, the method reduces costs and creates operational efficiencies for advertisers and other content providers to distribute ads and other entertainment/information to out-of-home and outdoor locations by reducing the labor costs to transport, install and remove ads from their locations, providing low cost opportunities for an advertiser to run a multiplicity of ads in the same outdoor or out-of-home venue from a centralized location, and allows an advertiser to create more timely ads for the consumer.

This feature increases the possibilities of delivering high impact, targeted advertisements that enhance the opportunity to communicate with a consumer, as well as using a variety of outdoor and out of home media in a completely coordinated manner, so long as the venues are electronic displays. For example, a particular concert performer appearing in a venue can be seen endorsing a soft drink in digital ads in the concourse. The same night, when a professional athletic event is taking place, the star of the team can be seen endorsing the same soft drink. This can extend to surrounding billboards, transit shelters and other outdoor displays surrounding the arena.

Moreover, if there are 20 arenas as that are connected to a digital network, the star of each individual sports team at each network affiliate venue can be seen endorsing the same soft drink simultaneously; the advertiser has purchased time for the same period.

In accordance with a further object of the invention, the method targets an advertisement that is relevant to the consumer for the time, place and event taking place.

This new business method will create a dynamic advertising distribution system which will allow an advertiser to display ads dynamically in a multiplicity of locations comprising non-affiliated third parties (billboards, transit shelters, malls, sports venues, etc.), and the ability to change and control the nature, frequency and time that these ads are displayed in an integrated manner. In short, a system that would apply the dynamics of a television or radio network to exist in out-of-home and outdoor locations.

Technology. This method and system will employ available technology and use it for creating a new paradigm in advertising and communications in outdoor locations.

A central server is deployed for each network. The content is uploaded from the production site and downloaded through high-speed phone lines or satellite transmission to a site server (having a computer readable storage media for storing multimedia material, such as ads, trailers for movies, information such as news, weather and traffic) at the network affiliate location(s).

Another server at the same affiliate location(s) is programmed remotely to display a certain content at a certain frequency or time of the day.

Content is continually refreshed, as desired. Dynamic updates can be sent to one or as many affiliates within the network, as desired. The network can be programmed to display ads multilingually, as desired. The network licenses this software from one or more companies specializing in developing this technology. (See drawings attached to the Provisional Patent Application 60/296,925).

1. A system and method for distributing, transmitting and displaying digital media through an electronic or similar network distribution system to affiliated or non-affiliated third party entities which own and/or control out-of-home and outdoor venues. Content will be displayed on high end displays such as LED screens, plasma screens, LED displays and front/rear projection systems-virtually any electronic video or audio device which can be connected to a computer. The network described in this invention is comprised of: distributing and displaying targeted digital content in the form of advertisements, entertainment or information, specifically: storing such content on a centralized server; distributing/transmitting the content to a network of remote servers to an unlimited number of affiliates located in out-of-home or outdoor locations; displaying the content in the order and frequency desired within such network; targeting such displays of advertising and other digital content based upon the needs of the advertiser or content owner and, monitoring the display of such content.

2. The system and method of claim 1, wherein said content selections include advertisements by one or more advertisers.

3. The system and method of claim 1, wherein said content selections include entertainment by one or more content providers.

4. The system and method of claim 1, wherein said content selections include timely information, such as news, traffic conditions, weather, scores, business data and the like provided by one or more content owner, or from publicly available sources.

5. The system and method of marketing and distributing multimedia advertisements to outdoor and out-home locations of claim 1, including providing a server system accessible by an advertiser over a communications network comprised of one or more affiliated or non-affiliated out-of-home or outdoor venue owners.

6. The system and method of marketing, distributing and displaying multimedia advertisements to outdoor and out-home locations of claim 1, including downloading digital material from said central server system for display to consumers on electronic display devices such as gas plasma screens, LCD screens, LED screens front and rear projection systems and other electronic displays.

7. The system and method of marketing and distributing multimedia advertisements to outdoor and out-home locations of claim 1, including the ability of a national advertiser to “localize” or customize its ad (time/event/city) over the outdoor and/or out-of-home network.

8. The system and method according to claim 1, which includes charging a fee to the content provider or advertiser to purchase time on the network, as opposed to [paying a fee to rent space in an outdoor or out-of-home location, which advertiser or content provider is, in consideration for such payment, is given access to the network and licensed the specified times/dates to display such content at network affiliate locations.

9. The system and method according to claim 1, which includes storing the digital media on the server and distributing the content to network affiliate servers.

10. The system and method according to claim 1, which includes transferring the digital media from the central network server and distributing the content to network affiliate site and display servers.

11. The system and method according to claim 1, whereby the central headend where the network server is located includes a technology to simultaneously transmit a multiple number of advertisements to corresponding affiliate network locations (e.g., billboards, transit shelters, malls, sports venues, buses, taxis, building walls) that are interfaced between said distribution network and said network affiliate servers and other devices, each said advertising and content stream targeted to different consumer demographics.

12. The system and method according to claim 1, which includes notifying the central network server that the advertisement or content has been displayed at each of the desired network affiliate servers at the time, date and frequency theretofore licensed.

13. The system and method according to claim 1, which includes transmitting the same advertisement in multiple languages as desired by the advertiser or content provider to network affiliate servers.

14. The system and method according to claim 1, which includes displaying the same advertisement in multiple languages within the network to network affiliates as desired by the advertiser or content provider to network affiliate servers at the same moment or at different times, as desired.

15. The system and method according the claim 1, which includes interconnecting an array of out-of-home and outdoor affiliate locations and venues and creating one or more networks owned and controlled by one or more advertiser, manufacturer, service provider seeking to distribute digital advertising and content over a digital network to non-affiliated out-of-home or outdoor venues.

16. The system and method according to claim 1, which includes displaying the advertisement or other content on out-of-home or outdoor electronic displays (gas plasma displays, LCD screens, LED screens, front screen projectors, rear screen projectors, etc.) installed in one or more of the affiliate locations and other content based upon the license accorded to the advertiser or content provider.

17. The system and method according to claim 1, which includes simultaneously displaying more than one advertisement for the same advertiser or content provider in the same time frame to one or more of the affiliate locations, with the advertisement selected to best target and reach a defined targeted audience, the time of day, the day of the week, the location of the affiliate, the event taking place.

18. The system and method by which an advertiser can create its own proprietary private digital/electronic network to deliver advertisements and other content to a network of non-affiliated third party out-of-home and outdoor venues, creating a channel devoted to branding its product and services.

19. The system and method by which more than one advertiser can create their own proprietary private digital/electronic network to deliver advertisements and other content to a network of non-affiliated third party out-of-home and outdoor venues, creating a channel devoted to branding their product and services.

20. The system and method by which one or more copyright and/or content and or franchise/league owners, such as a professional and college sports teams and leagues, consumer products or services companies, motion picture studios, television networks or other media companies can create their own proprietary private digital/electronic outdoor or out-of-home network to deliver advertisements, entertainment, information and other content to a network of non-affiliated third party out-of-home and outdoor venues, creating a channel devoted to branding their product and services.
